(19) United States
(12) Patent Application Publication
(10) Pub. No.: US 2025/0289917 A1
(43) Pub. Date: Sep. 18, 2025

(54) MINIRANDOM PROPYLENE COPOLYMER FOR SHEET APPLICATIONS

(71) Applicant: Fina Technology, Inc., Houston, TX (US)

(72) Inventors: Michael A. McLeod, Houston, TX (US); Peng Li, Sugar Land, TX (US); Fengkui Li, Houston, TX (US); Toby N. Stevens, League City, TX (US); Jesse Ray Dillman, Alvin, TX (US)

(73) Assignee: Fina Technology, Inc., Houston, TX (US)

(21) Appl. No.: 19/082,957

(22) Filed: Mar. 18, 2025

Related U.S. Application Data
(60) Provisional application No. 63/566,504, filed on Mar. 18, 2024.

(51) Int. Cl. C08F 210/16; C08J 5/18

(52) U.S. Cl. CPC C08F 210/16; C08J 5/18; C08F 2800/20; C08J 2323/16

(57) ABSTRACT

A polypropylene random copolymer comprising (i) from about 0.2 wt. % to about 1.5 wt. % ethylene; and (ii) a nucleator selected from the group consisting of sodium benzoate, derivatives of dibenzylidene sorbitol (DBS), nonitol, trisamide-containing compounds, organophosphate salts and combinations thereof, wherein the copolymer has a melt flow rate of from about 0.5 dg/min. to about 5.0 dg/min. and a xylene solubles content of from about 1.0 wt. % to about 4.0 wt. %.

### CROSS-REFERENCE TO RELATED APPLICATIONS

This application claims benefit of U.S. provisional patent application Ser. No. 63/566,504 filed Mar. 18, 2024, and entitled “MINIRANDOM PROPYLENE COPOLYMER FOR SHEET APPLICATIONS,” which is hereby incorporated herein by reference in its entirety for all purposes.

### STATEMENT REGARDING FEDERALLY SPONSORED RESEARCH OR DEVELOPMENT

Not applicable.

### TECHNICAL FIELD

The present disclosure relates generally to polypropylene compositions. More particularly, the present disclosure relates to polypropylene copolymer compositions. Still more particularly, the present disclosure relates to minirandom copolymer films.

### BACKGROUND

Polypropylene (PP) is a widely used plastic that has high modulus, high tensile strength, good heat resistance, and other favorable properties in the solid-state. Synthetic polymeric materials, particularly polypropylene resins, are manufactured into a variety of end-use articles ranging from medical devices to packaging materials.

A number of improvements in performance properties of PP could allow for increased applications. Thus, an ongoing need exists for new PP materials with improved performance properties.

### BRIEF SUMMARY OF THE DISCLOSURE

A polypropylene random copolymer comprising (i) from about 0.2 wt. % to about 1.5 wt. % ethylene; and (ii) a nucleator selected from the group consisting of sodium benzoate, derivatives of dibenzylidene sorbitol (DBS), nonitol, trisamide-containing compounds, organophosphate salts and combinations thereof, wherein the copolymer has a melt flow rate of from about 0.5 dg/min. to about 5.0 dg/min. and a xylene solubles content of from about 1.0 wt. % to about 4.0 wt. %.

### DETAILED DESCRIPTION

The following discussion is directed to various exemplary aspects. However, one of ordinary skill in the art will understand that the examples disclosed herein have broad application, and that the discussion of any aspect is meant only to be exemplary of that aspect, and not intended to suggest that the scope of the disclosure, including the claims, is limited to that aspect.

The figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . ” As used herein, the terms “approximately,” “about,” “substantially,” and the like mean within 10% (i.e., plus or minus 10%) of the recited value. Thus, for example, a recited angle of “about 80 degrees” refers to an angle ranging from 72 degrees to 88 degrees.

Unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary.

Disclosed herein are minirandom polypropylene copolymers having improved performance properties, which are hereinafter designated “miniPPR(s)”. For example, the miniPPRs of the present disclosure and/or specimens thereof may display improvements in one or more properties such as flexural modulus, heat deflection temperature and crystallization temperature. The improvements can be achieved using specific formulations as disclosed herein. For example, a reduced amount of ethylene may be used in some aspects that can result in a reduced xylene solubles level. This in turn can result in a number of desirable properties as described herein.

In one or more aspects, the comonomer of the miniPPR comprises ethylene, butene, pentene, hexene, heptene, octene, nonene, decene, undecene, dodecene, norbornene, ethylidenenorbornene, vinylnorbornene, norbornadiene, dicyclopentadiene, cyclopentene, cycloheptene, cyclooctene, cyclooctadiene cyclododecene, 7-oxanorbornene, 7-oxanorbornadiene, substituted derivatives thereof, isomers thereof or combinations thereof.

In one or more aspects, a miniPPR for use in the present disclosure comprises a polypropylene-ethylene random copolymer where ethylene is present in amounts ranging from about 0.2 weight percent (wt. %) to about 1.5 wt. %; additionally or alternatively from about 0.2 wt. % to about 0.8 wt. %; additionally or alternatively from about 0.2 wt. % to about 0.6 wt. %; additionally or alternatively about 0.2 wt. %, about 0.3 wt. %, about 0.4 wt. %, about 0.5 wt. %, about 0.6 wt. %, about 0.7 wt. %, about 0.8 wt. %, about 0.9 wt. %, about 1 wt. %, about 1.1 wt. %, about 1.2 wt. %, about 1.3 wt. %, about 1.4 wt. %, or about 1.5 wt. % based on the total weight of the miniPPR.

In such aspects, the miniPPR comprises polypropylene in an amount of from about 95.0 wt. % to about 99.8 wt. %; additionally or alternatively from about 96 wt. % to about 98 wt. %; additionally or alternatively from about 97 wt. % to about 98 wt. %; additionally or alternatively from about 98.5 wt. % to about 99.8 wt. %, additionally or alternatively from about 99.2 wt. % to about 99.8 wt. %; additionally or alternatively from about 99.4 wt. % to about 99.8 wt. %; additionally or alternatively about 95 wt. %, about 95.5 wt. %, about 96 wt. %, about 96.5 wt. %, about 97 wt. %, about 97.5 wt. %, about 98 wt. %, about 98.5 wt. %, about 98.6 wt. % about 98.7 wt. %, about 98.8 wt. %, about 98.9 wt. %, about 99 wt. %, about 99.1 wt. %, about 99.2 wt. %, about 99.3 wt. %, about 99.4 wt. %, about 99.5 wt. %, about 99.6 wt. %, about 99.7 wt. %, about 99.8 wt. % based on the total weight of the miniPPR. Hereinafter, the disclosure will refer to the miniPPR as comprising a propylene ethylene copolymer although as disclosed herein other copolymers of propylene are contemplated.

A miniPPR for use in the present disclosure may be prepared using any suitable methodology. In an aspect, the miniPPR is prepared in a polymerization reactor in the presence of a Ziegler-Natta catalyst system. A Ziegler-Natta catalyst system generally refers to a catalyst system containing a transition metal compound comprising a supported Group IV metal (e.g., Ti, Zr, Hf), an organoaluminum compound and one or more Lewis bases as electron donors. Electron donors introduced during the preparation of the Ziegler-Natta catalyst are termed internal electron donor(s), and those added in olefin polymerization are termed external electron donor(s).

A catalyst system suitable for use in the present disclosure may comprise one or more external electron donors. Nonlimiting examples of external electron donors suitable for use in the preparation of a miniPPR include monofunctional or polyfunctional carboxylic acids, carboxylic anhydrides, carboxylic esters, ketones, ethers, alcohols, lactones, organophosphorus compounds, organosilicon compounds or combinations thereof. In one or more aspects, the external electron donor may include without limitation diphenyldimethoxysilane (DPMS), cyclohexylmethyldimethoxysilane (CDMS), diisopropyldimethoxysilane, dicyclopentyldimethoxysilane (CPDS) or combinations thereof.

In another aspect, the miniPPR is prepared by blending two or more polymer resins using any suitable methodology (e.g., compounding). In one or more aspects, the miniPPR is a blend a polypropylene homopolymer and a polypropylene random copolymer and is herein designated the miniPPR blend. In one or more aspects, the homopolymer in the miniPPR blend may be characterized by a melt flow rate of from about 1 g/10 min to about 10 g/10 min, less than about 0.1% ethylene and a xylene solubles content of from about 0.2 wt. % to about 3.0 wt. %. In one or more aspects, the homopolymer in the miniPPR blend may be characterized by a melt flow rate of from about 1 g/10 min to about 10 g/10 min, an ethylene content of less than about 0.1 wt. % and a xylene solubles content of from about 0.2 wt. % to about 3.0 wt. %. In one or more aspects, the homopolymer in the miniPPR blend may be characterized by a density of from about 8.9 g/cc to about 9.1 g/cc.

In one or more aspects, the random copolymer in the miniPPR blend may be characterized by a melt flow rate of from about 1 g/10 min to about 10 g/10 min. In one or more aspects, the random copolymer in the miniPPR blend may be characterized by a density of from about 8.9 g/cc to about 9.1 g/cc. In one or more aspects, the random copolymer is characterized by an ethylene content of about 0.2 wt. % to about 3.0 wt. %, and a xylene solubles content of from about 1.0 wt. % to about 5.0 wt. %.

In aspects, the ratio of random copolymer to hompolymer in the miniPPR blend may be about 10:90; additionally or alternatively about 20:80; additionally or alternatively about 25:75 additionally or alternatively about 40:60. In one or more aspects, the random copolymer is present in the miniPPR blend in an amount of equal to or less than about 50 wt. %.

The miniPPR blend may be prepared using any suitable methodology for preparing a homogeneous mixture of polymers. For example, the miniPPR blend may be prepared by physically mixing pellets of the polypropylene homopolymer and the polypropylene random copolymer to form a mixture and melting the physically blended mixture. In alternative aspects, the polypropylene homopolymer and the polypropylene random copolymer are melted to form individual melts in a extrusion step, and subsequently combined to form a melt mix.

The resulting miniPPR blend would be either (i) a single pellet solution where the two components were intimately melt mixed through an extrusion process to form pellets or (ii) a finished article where the two components were intimately melt mixed thorough an extrusion process to form the final article. Nonlimiting examples of conversion processes for the formation of a miniPPR blend include melt extrusion are known to those skilled in the art and include sheet extrusion, injection molding, blow molding, fiber spinning, blown film, cast film, biaxially oriented film, raffia and strapping processes.

Hereinafter the disclosure will refer to a miniPPR and may be a miniPPR prepared via polymerization reactor or a miniPPR blend. In some aspects, one or more additives may be included in the miniPPR to produce formulations that achieve some user and/or process goal. Nonlimiting examples of performance enhancing additives that can be introduced to the miniPPR include stabilizers, ultra-violet screening agents, oxidants, anti-oxidants, anti-static agents, ultraviolet light absorbents, fire retardants, processing oils, mold release agents, coloring agents, pigments, dyes, fillers, nucleators, clarifiers, and the like.

In one or more aspects, the miniPPR comprises a nucleator, a clarifier, or both. Nucleators and clarifiers (a sub-class of nucleators) increase clarity by nucleating or increasing the rate of crystal formation in the resin. In general, both clarifiers and nucleators nucleate but not all nucleators clarify, although many do significantly reduce haze. During a normal crystallization process in which no clarifier has been added, relatively large crystals tend to form. These large crystals refract light and thus can reduce the clarity of a resin. When a clarifier is added, the higher rate of crystal formation induces formation of smaller crystals such as spherulites that tend to scatter less light. The smaller crystals allow light to pass without refraction, thus increasing the clarity of the resin.

Nonlimiting examples of nucleators suitable for use in the miniPPR include aromatic carboxylic acid salts such as sodium benzoate, derivatives of dibenzylidene sorbitol (DBS), nonitol and derivatives thereof, trisamide-containing compounds, organophosphate salts and combinations thereof. Nucleators may be included in the miniPPR in an effective amount. For example, the nucleator may be present in an amount of from about 0.001 wt. % to about 20 wt. %; additionally or alternatively from about 0.1 wt. % to about 18 wt. %; additionally or alternatively from about 0.5 wt. % to about 15 wt. % based on the total weight of the miniPPR. Additives for inclusion with a miniPPR may be included singularly or in combination in amounts effective to produce the desired performance characteristics.

In one or more aspects, a miniPPR of the present disclosure is characterized by a melt flow rate of from about 0.5 g/10 min. to about 5.0 g/10 min.; additionally or alternatively from about 0.8 g/10 min. to about 4.5 g/10 min.; additionally or alternatively from about 1.0 g/10 min. to about 4.0 g/10 min. The melt flow rate (or melt flow index) may be defined by various standards including ASTM D1238, ASTM D3364, or ISO 1133. In one aspect, the melt flow rate is determined in accordance with ASTM D1238 at 230° C. with a load of 2.16 kg. Generally, the melt flow rate indicates the quantity of a melted polymer resin that will flow through an orifice at a specified temperature and under a specified load.

In an aspect, a miniPPR of the type described herein may be characterized by a weight average molecular weight (M_{w}) of from about 300,000 g/mol to about 450,000 g/mol; additionally or alternatively from about 325,000 g/mol to about 425,000 g/mol; additionally or alternatively from about 350,000 g/mol to about 410,000 g/mol; a number average molecular weight (Mₙ) of from about 40,000 g/mol to about 60,000 g/mol; additionally or alternatively from about 45,000 g/mol to about 5,8000 g/mol; additionally or alternatively from about 48,000 g/mol to about 55,000 g/mol; and a z-average molecular weight (M_{z}) of from about 400,000 g/mol to about 1,500,000 g/mol; additionally or alternatively from about 1×10⁶ g/mol to about 2×10⁶ g/mol; additionally or alternatively from about 1.2×10⁶ g/mol to about 1.95×10⁶ g/mol; additionally or alternatively from about 1.4×10⁶ g/mol to about 1.85×10⁶ g/mol. The weight average molecular weight describes the size average of a polymer composition and can be calculated according to equation 1:

$${M}_{w} = \frac{{\sum }_{i} {N}_{i} {M}_{i}^{2}}{{\sum }_{i} {N}_{i} {M}_{i}} \qquad ( 1 )$$

wherein Nᵢ is the number of molecules of molecular weight Mᵢ. All molecular weight averages are expressed in gram per mole (g/mol) or Daltons (Da). The number average molecular weight is the common average of the molecular weights of the individual polymers calculated by measuring the molecular weight _{Mi} of Nᵢ polymer molecules, summing the weights, and dividing by the total number of polymer molecules, according to equation 2:

$${M}_{n} = \frac{{\sum }_{i} {N}_{i} {M}_{i}}{{\sum }_{i} {N}_{i}} \qquad ( 2 )$$

The z-average molecular weight is a higher order molecular weight average which is calculated according to equation 3:

$${M}_{z} = \frac{{\sum }_{i} {N}_{i} {M}_{i}^{3}}{{\sum }_{i} {N}_{i} {M}_{i}^{2}} \qquad ( 3 )$$

The miniPPR may be characterized by the ratio of the M_{w} to the Mₙ (D) which is also referred to as the polydispersity index (PDI) or more simply as polydispersity of from about 4 to about 12; additionally or alternatively from about 5 to about 10, additionally or alternatively from about 6 to about 10; additionally or alternatively from about 6 to about 9.

The ratio of M_{z} to the M_{w} (D′) is another indication of the breadth of the MWD of a polymer. The miniPPR may be further characterized by a ratio (Mz/Mw) of from about 4 to about 5, alternatively from about 4.0 to about 4.9, or alternatively from about 4.2 to about 4.8.

In one or more aspects, the miniPPR may be further characterized by a peak molecular weight of from about 150,000 g/mol to about 200,000 g/mol; additionally or alternatively for about 160,000 g/mol to about 195,000 g/mol; additionally or alternatively from about 160,000 g/mol to about 180,000 g/mol. The “peak molecular weight” (Mₚ) refers to the molecular weight at which the most chains in a sample are found and represents the number of molecules of molecular weight Mᵢ.

In one or more aspects, the miniPPR has a xylene solubles content ranging from about 1.0 wt. % to about 4.0 wt. %; additionally or alternatively from about 1.0 wt. % to about 3.0 wt. %; additionally or alternatively from about 1.2 wt. % to about 2.5 wt. % based on the total weight of the miniPPR. The term “xylene solubles” is defined as the weight percent of resin that remains in solution after a sample of resin is dissolved in hot xylene and the solution is allowed to cool to 25° C. The xylene solubles content may be determined in accordance ASTM 5492.

In one or more aspects, the miniPPR has a crystallization temperature of from about 120° C. to about 140° C.; additionally or alternatively from about 125° C. to about 140° C.; additionally or alternatively from about 125° C. to about 138° C. In one or more aspects, the miniPPR has a crystallization enthalpy of from about 90 Joules per gram (J/g) to about 125 J/g; additionally or alternatively from about 95 J/g to about 120 J/g; additionally or alternatively from about 90 J/g to about 115 J/g. The crystallization temperature (T_{c}) refers to the temperature at which the polymer chains transition from a disordered, amorphous state to a more ordered, crystalline state, and the enthalpy of crystallization (H_{c}) refers the amount of heat released during this process.

In one or more aspects, the miniPPR has a degree of crystallinity of equal to or greater than about 45%; additionally or alternatively equal to or greater than about 47%; additionally or alternatively equal to or greater than about 48%. Herein the term “degree of crystallinity” refers to the fraction of the ordered molecules in a polymer and may be determined using any suitable methodology such as differential scanning calorimetry (DSC) in accordance with ASTM D3418.

In one or more aspects, the miniPPR has a melting temperature of from about 150° C. to about 200° C.; additionally or alternatively from about 155° C. to about 175° C.; additionally or alternatively from about 155° C. to about 170° C. In one or more aspects, the miniPPR has a melting enthalpy of from about 90 J/g to about 125 J/g; additionally or alternatively from about 95 J/g to about 120 J/g; additionally or alternatively from about 90 J/g to about 115 J/g. The melting temperature (Tₘ) of a polymer is the temperature at which it transitions from a solid to a liquid state, and the enthalpy of melting (ΔHₘ) is the amount of energy required to melt a polymer.

In one or more aspects, the miniPPR has a heat deflection temperature (HDT) of equal to or greater than about 212° F. (100° C.); additionally or alternatively equal to or greater than about 222° F. (105° C.); additionally or alternatively about 225° F. (107° C.); additionally or alternatively from about 225; additionally or alternatively from about 212° F. (100° C.) to about 225° F. (107° C.) at a load of 66 psi when measured in accordance with ASTM D648. The HDT is a measure of a polymer's resistance to alteration under a given load at an elevated temperature.

An article formed from a miniPPR of the present disclosure may have a flexural modulus ranging from equal to or greater than about 220 kilopounds per square inch (kpsi) to about 290 kpsi; additionally or alternatively from about 230 kpsi to about 290 kpsi; additionally or alternatively from about 240 kpsi to about 290 kpsi as determined in accordance with ASTM D790. Herein the term “flexural modulus” or bending modulus refers to the ratio of stress to strain in flexural deformation, or the tendency for a material to resist bending in other words, stiffness.

In one or more aspects, a miniPPR is formed into a film. The film may have a haze of from about 5% to about 60%; additionally or alternatively from about 10% to about 55%; additionally or alternatively from about 10% to about 100% depending on the film thickness. In one or more aspects, the film has a haze to about equal to or less than about 55%; additionally or alternatively equal to or less than about 50%; additionally or alternatively equal to or less than about 45% as determined using an 80 mil film sample measured in accordance with ASTM D-1003. Herein the term “haze” refers to the percentage of incident light scattered by more than 2.5° through the plastic specimen.

The film may be characterized by a clarity of equal to or greater than about 98%; additionally or alternatively equal to or greater than about 99%; additionally or alternatively equal to or greater than about 99.2% and may be determined in accordance with ASTM D1003.

The film may be characterized by a gloss at 45° of from about 85 to about 110; additionally or alternatively from about 90 to about 105 or alternatively from about 90 to about 100 as determined in accordance with ASTM D1003. The gloss at 45° measures the amount of light reflected at a 45-degree angle, providing a measure of the polymer surface's luster or shininess.

The film may be characterized by a yellowness index ranging from 0 to −25, additionally or alternatively from about −0.1 to about −20; additionally or alternatively from about −0.5 to about −20.

The film may be characterized by a tensile strength at yield ranging from about 5000 psi to about 7000 psi, additionally or alternatively from about 5500 psi to about 7000 psi; additionally or alternatively from about 5000 psi to about 5800 psi. In one or more aspects, the film is characterized by a tensile strength at break ranging from about 1500 psi to about 4000 psi, additionally or alternatively from about 2000 psi to about 3800 psi; additionally or alternatively from about 2000 psi to about 4000 psi.

The tensile strength at yield refers to the stress a material can withstand without permanent deformation of the material while the tensile strength at yield refers to amount of deformation elongation that occurs without permanent deformation of the material determined in accordance with ASTM D882. In an aspect, the tensile elongation at yield of from about 2.0% to about 10%, additionally or alternatively from about 4.0% to about 9.0%, additionally or alternatively from about 4.0% to about 8.0%. The elongation at yield is the percentage increase in length that occurs at the yield point of a material, as determined in accordance with ASTM D882.

In one or more aspects, the miniPPR is molded into an end use article. Molding of the miniPPR may be carried out using any suitable molding method. Nonlimiting examples of suitable molding methods include injection molding, extrusion molding, blow molding, vacuum molding, thermoforming, inflation molding, calender molding, slush molding method, dip molding and foam molding.

Nonlimiting examples of end use articles formed from a miniPPR of the type disclosed herein include resin parts for automobiles such as a bumper, a dashboard, an instrument panel, a molding, an interior surface material and a packing; resin parts for household appliances, such as a refrigerator, a washing machine and a vacuum cleaner; household goods such as tableware, a bucket and a bathing implement; connecting parts such as connectors; miscellaneous goods such as toys; storage containers such as a tank and a bottle; medical supplies such as a medical pack, a syringe, a catheter, and a medical tube; building materials such as a wall material, a flooring material, a window frame and wallpaper; agricultural materials such as an electric wire covering material, a house and a tunnel; food packaging materials such as a wrap and a tray; various molded articles such as a film and a sheet; and fibers.

In one or more aspects, the miniPPR is formed into sheets through a sheet extrusion process. Sheet extrusion processes may include forcing molten polymer through a slit die, which is then passed over calendaring and polishing rolls. Sheet thickness is defined as thicker than 10 mils (250 microns).

In one or more aspects, the miniPPR is formed into films through a blown film process. Blown film processes may include forcing molten polymer through a circular die which is then blown. The resultant bubble is then flattened and cut into strips, that when rolled produces rolls of flat film. Film thickness is defined as 10 mils (250 microns) and thinner.

The miniPPRs disclosed herein have the potential to provide articles with increased stiffness that could permit downgauging, which is attractive for conserving material use. Another aspect would be increased high temperature performance; microwavability, hot fill performance and autoclavability for medical applications are all opportunities where improvements would curry interest from market participants.

### Additional Disclosure

A first aspect which is a polypropylene random copolymer comprising (i) from about 0.2 wt. % to about 1.5 wt. % ethylene; and (ii) a nucleator selected from the group consisting of sodium benzoate, derivatives of dibenzylidene sorbitol (DBS), nonitol, trisamide-containing compounds, organophosphate salts and combinations thereof, wherein the copolymer has a melt flow rate of from about 0.5 dg/min. to about 5.0 dg/min. and a xylene solubles content of from about 1.0 wt. % to about 4.0 wt. %.

A second aspect which is the copolymer of the first aspect wherein the copolymer has a xylene solubles content of from about 1.0 wt. % to about 3.0 wt. %.

A third aspect which is the copolymer of any of the first through second aspects wherein the copolymer has a weight average molecular weight of form about 40,000 g/mol to about 60,000 g/mol.

A fourth aspect which is the copolymer of any of the first through third aspects wherein the copolymer has a z-average molecular weight of form about 400,000 g/mol to about 1,500,000 g/mol.

A fifth aspect which is the copolymer of any of the first through fourth aspects wherein the copolymer has a molecular weight distribution of from about 4 to about 12.

A sixth aspect which is the copolymer of any of the first through fifth aspects wherein the copolymer has a ratio of weight average molecular weight to z-average molecular weight of from about 4 to about 5.

A seventh aspect which is the copolymer of any of the first through sixth aspects wherein the copolymer has a peak molecular weight of from about 160,000 g/mol to about 195,000 g/mol.

An eighth aspect which is the copolymer of any of the first through seventh aspects wherein the copolymer has a 1% flexural modulus of from about 220 kpsi to about 290 kpsi.

A ninth aspect which is the copolymer of any of the first through eighth aspects wherein the copolymer has a crystallization temperature of from about 120° C. to about 140° C.

A tenth aspect which is the copolymer of any of the first through ninth aspects wherein the copolymer has a crystallization enthalpy of from about 90 J/g to about 125 J/g.

An eleventh aspect which is the copolymer of any of the first through tenth aspects wherein the copolymer has a melting temperature of from about 150° C. to about 200° C.

A twelfth aspect which is the copolymer of any of the first through eleventh aspects wherein the copolymer has a melting enthalpy of from about 90 J/g to about 115 J/g.

A thirteenth aspect which is the copolymer of any of the first through twelfth aspects wherein the copolymer has a percent crystallinity of equal to or greater than about 45%.

A fourteenth aspect which is the copolymer of any of the first through thirteenth aspects wherein the copolymer has a heat deflection temperature of equal to or greater than about 212° F. (100° C.).

A fifteenth aspect which is film of any of the first through fourteenth aspects wherein the film has a haze of from about 5% to about 60%.

A sixteenth aspect which is the film of any of the second through fourteenth aspects wherein the film has a haze of from about 5% to about 60%.

A seventeenth aspect which is the film of the fifteenth aspect wherein the film has a clarity of greater than about 98%.

An eighteenth aspect which is the film of the sixteenth aspect wherein the film has a clarity of greater than about 98%.

A nineteenth aspect which is the film of the fifteenth aspect, wherein the film has a gloss at 45° of from about 65 to about 110.

A twentieth aspect which is the film of the sixteenth aspect, wherein the film has a gloss at 45° of from about 65 to about 110.

A twenty-first aspect which is the film of the fifteenth aspect wherein the film has a tensile strength at yield of from about 5000 psi to about 7000 psi.

A twenty-second aspect which is the film of the sixteenth aspect wherein the film has a tensile strength at yield of from about 5000 psi to about 7000 psi.

A twenty-third aspect which is the film of the fifteenth aspect, wherein the film has a tensile strength at break of from about 1500 psi to about 4000 psi

A twenty-fourth aspect which is the film of the sixteenth aspect wherein the film has a tensile strength at break of from about 1500 psi to about 4000 psi.

### EXAMPLES

The aspects having been generally described, the following examples are given as particular aspects of the disclosure and to demonstrate the practice and advantages thereof. It is understood that the examples are given by way of illustration and are not intended to limit the specification of the claims in any manner.

### Example 1

The properties of several miniPPR formulations were investigated. Eight compositions were compounded and were numbered samples 1-8. Compositions were prepared by blending two discrete reactor powders and then extruding the blend to form a final pellet while formulations. Samples 1, 6 and 7 were each made from one reactor powder. All additives were intimately blended with the reactor powder prior to being introduced to the extruder hopper. The physical properties for each formulation are presented in Tables 1 and 2.

The polymer color was measured and is indicated by the variables L, a, b and YI where L which refers to luminance and represents the lightness or darkness of a color, ranging from 0 (black) to 100 (white) l a refers to the color component ranging from green to red; b refers to the color component ranging from blue to yellow. “YI” refers to the Yellowness Index, a measure of how much a sample deviates from a white or clear color towards yellow, often used to assess polymer degradation.

TABLE 1

| Physical Property | Unit | Method | Sample 1 | Sample 2 | Sample 3 | Sample 4 |
|---|---|---|---|---|---|---|
| DSC | | ASTM D- | | | | |
| | | 3418 | | | | |
| Crystallization | ° C. | ASTM D- | 124.85 | 127.57 | 129.54 | 126.7 |
| Temp. (Tc) | | 3418 | | | | |
| Crystallization | J/g | ASTM D- | 96.32 | 103.09 | 104.52 | 101.83 |
| Enthalpy (−ΔHc) | | 3418 | | | | |
| Melting Temp. | ° C. | ASTM D- | 159.02 | 164.76 | 165.16 | 164.82 |
| (Tm) | | 3418 | | | | |
| Melting Enthalpy | J/g | ASTM D- | 99.279 | 106.2 | 107.95 | 104.68 |
| (ΔHm) | | 3418 | | | | |
| Crystallinity | | ASTM D- | 47.5% | 50.8% | 51.7% | 50.1% |
| | | 3418 | | | | |
| MFR | dg/min | ASTM D- | 4.078 | 3.09 | 2.91 | 2.981 |
| | | 1238 | | | | |
| GPC | | Via a Polymer | | | | |
| | | Char GPC-IR | | | | |
| Mn | g/mol | Via a Polymer | 49893 | 52657 | 52822 | 52694 |
| | | Char GPC-IR | | | | |
| Mw | g/mol | Via a Polymer | 340010 | 375581 | 383660 | 375622 |
| | | Char GPC-IR | | | | |
| Mz | g/mol | Via a Polymer | 1453279 | 1563275 | 1627739 | 1555462 |
| | | Char GPC-IR | | | | |
| D = Mw/Mn | N/A | Via a Polymer | 6.81 | 7.13 | 7.26 | 7.13 |
| | | Char GPC-IR | | | | |
| D′ = Mz/Mw | N/A | Via a Polymer | 4.27 | 4.16 | 4.24 | 4.14 |
| | | Char GPC-IR | | | | |
| Mp | g/mol | Via a Polymer | 163138 | 177658 | 177658 | 175147 |
| | | Char GPC-IR | | | | |
| Xylene Solubles | % | FIPA | 3.78 | 2.19 | 2.23 | 2.19 |
| Color | | ASTM D- | | | | |
| | | 6290 | | | | |
| Color L | N/A | ASTM D- | 74.6 | 75.9 | 75.3 | 74.3 |
| | | 6290 | | | | |
| Color a | N/A | ASTM D- | −0.72 | −0.55 | −0.55 | 2.43 |
| | | 6290 | | | | |
| Color b | N/A | ASTM D- | −0.17 | −0.57 | −0.61 | −9.17 |
| | | 6290 | | | | |
| YI | N/A | ASTM D- | −1.18 | −1.96 | −2.06 | −19.81 |
| | | 6290 | | | | |

| Physical Property | Unit | Sample 5 | Sample 6 | Sample 7 | Sample 8 |
|---|---|---|---|---|---|
| DSC | | | | | |
| Crystallization | ° C. | 126.46 | 129.12 | 127.58 | 126.58 |
| Temp. (T_{c}) | | | | | |
| Crystallization | J/g | 96.845 | 111.1 | 97.555 | 95.763 |
| Enthalpy (−ΔH_{c}) | | | | | |
| Melting Temp. | ° C. | 162.67 | 168.58 | 164.97 | 162.68 |
| (Tₘ) | | | | | |
| Melting Enthalpy | J/g | 99.051 | 113.06 | 100.13 | 97.487 |
| (ΔHₘ) | | | | | |
| Crystallinity | | 47.4% | 54.1% | 47.9% | 46.6% |
| MFR | dg/min | 3.957 | 2.41 | 3.654 | 3.747 |
| GPC | | | | | |
| Mₙ | g/mol | 51227 | 55536 | 50297 | 50246 |
| M_{w} | g/mol | 358878 | 406100 | 389587 | 358101 |
| M_{z} | g/mol | 1508772 | 1632264 | 1869695 | 1580790 |
| D = M_{w}/Mₙ | N/A | 7.01 | 7.31 | 7.75 | 7.13 |
| D′ = M_{z}/M_{w} | N/A | 4.20 | 4.02 | 4.80 | 4.41 |
| Mₚ | g/mol | 172674 | 190787 | 167835 | 167835 |
| Xylene Solubles | % | 2.78 | 0.96 | 4.10 | 3.87 |
| Color | | | | | |
| Color L | N/A | 75 | 75.1 | 74.4 | 74.5 |
| Color a | N/A | −0.64 | −0.54 | −0.76 | −0.69 |
| Color b | N/A | −0.29 | −0.81 | 0.06 | −0.08 |
| YI | N/A | −1.39 | −2.54 | −0.68 | −0.96 |

TABLE 2

| Physical | | | | | | | | | |
|---|---|---|---|---|---|---|---|---|---|
| Property | Unit | Sample 1 | Sample 2 | Sample 3 | Sample 4 | Sample 5 | Sample 6 | Sample 7 | Sample 8 |
| MFR | g/10 | 3.5 | 2.8 | 2.8 | 2.8 | 3.1 | 2 | 2.8 | 3.1 |
| | min | | | | | | | | |
| Haze | — | 6.7 | 7.7 | 10.2 | 7.7 | 7.0 | 10 | 7.3 | 7.1 |
| (0.02 inch | | | | | | | | | |
| Thick) | | | | | | | | | |
| Haze | — | 19.7 | 22.3 | 25.9 | 23.1 | 20.2 | 25 | 21.2 | 21.3 |
| (0.04 inch | | | | | | | | | |
| Thick) | | | | | | | | | |
| Haze | — | 28.6 | 31.8 | 36.3 | 40.3 | 30.1 | 36.1 | 30.9 | 29.6 |
| (0.06 inch | | | | | | | | | |
| Thick) | | | | | | | | | |
| Haze | — | 39.4 | 42.7 | 46.9 | 53.8 | 41.2 | 47.5 | 41.7 | 40 |
| (0.08 inch | | | | | | | | | |
| Thick) | | | | | | | | | |
| Clarity | — | 99.4% | 99.1% | 99.0% | 99.1% | 99.3% | 99.0% | 99.2% | 99.3% |
| Gloss (45) | — | 97.7 | 92.3 | 90.2 | 92.5 | 103.0 | 93.8 | 101.0 | 99.8 |
| Tensile | Psi | 5000(±27) | 5470(±81) | 5500(±59) | 5180(±50) | 5290(±67) | 5740(±9) | 5150(±43) | 5020(±43) |
| Strength @ | | | | | | | | | |
| Yield | | | | | | | | | |
| Tensile | Psi | 2920(±203) | 2706(±412) | 2020(±312) | 3220(±253) | 2270(±426) | 1780(±418) | 2280(±652) | 2590(±372) |
| Strength @ | | | | | | | | | |
| Break | | | | | | | | | |
| Tensile | % | 8.5(±0.1) | 6.5(±0.1) | 6.0(±0.1) | 6.9(±0.1) | 7.4(±0.1) | 4.7(±0.1) | 7.8(±0.1) | 8.1(±0.1) |
| Elongation @ | | | | | | | | | |
| Yield | | | | | | | | | |

The results demonstrate reducing the amount of ethylene from approximately 4 wt. % to 2 wt. % gave a miniPPR with peak crystallization and melting temperatures similar to a polypropylene homopolymer (PPH) having approximately 4 wt. % xylene solubles (XS 4 wt. %). Further reducing the ethylene content from approximately 4 wt. % to 2 wt. % resulted in a miniPPR with crystallization and melting enthalpies significantly above that of either polypropylene homopolymer or miniPPR with XS of approximately 4 wt. %. The results further demonstrated the ability of a miniPPR of the type disclosed herein to achieve higher heats of fusion and melting versus a polypropylene homopolymer with a higher XS content regardless of the three nucleators used.

While various aspects have been shown and described, modifications thereof can be made by one skilled in the art without departing from the spirit and teachings of the disclosure. The aspects described herein are exemplary only, and are not intended to be limiting. Many variations and modifications of the aspects disclosed herein are possible and are within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes 2, 3, 4 etc.; greater than 0.10 includes 0.11, 0.12, 0.13, etc.). Use of the term “optionally” with respect to any element of a claim is intended to mean that the subject element is required, or alternatively is not required. Both alternatives are intended to be within the scope of the claim. Use of broader terms such as comprises includes having etc. should be understood to provide support for narrower terms such as consisting of consisting essentially of comprised substantially of etc.

Accordingly the scope of protection is not limited by the description set out above but is only limited by the claims which follow, that scope including all equivalents of the subject matter of the claims. Each and every claim is incorporated into the specification as an aspect of the present disclosure. Thus, the claims are a further description and are an addition to the aspects disclosed herein. The discussion of a reference herein is not an admission that it is prior art to the present disclosure, especially any reference that may have a publication date after the priority date of this application. The disclosures of all patents, patent applications, and publications cited herein are hereby incorporated by reference, to the extent that they provide exemplary %, procedural or other details supplementary to those set forth herein.

What is claimed is:

1. A polypropylene random copolymer, comprising:
(i) from about 0.2 wt. % to about 1.5 wt. % ethylene; and
(ii) a nucleator selected from the group consisting of sodium benzoate, derivatives of dibenzylidene sorbitol (DBS), nonitol, trisamide-containing compounds, organophosphate salts, and combinations thereof, wherein the copolymer has a melt flow rate of from about 0.5 dg/min. to about 5.0 dg/min. and a xylene solubles content of from about 1.0 wt. % to about 4.0 wt. %.

2. The copolymer of claim 1, wherein the copolymer has a xylene solubles content of from about 1.0 wt. % to about 3.0 wt. %.

3. The copolymer of claim 1, wherein the copolymer has a weight average molecular weight of form about 40,000 g/mol to about 60,000 g/mol.

4. The copolymer of claim 1, wherein the copolymer has a z-average molecular weight of form about 400,000 g/mol to about 1,500,000 g/mol.

5. The copolymer of claim 1, wherein the copolymer has a molecular weight distribution of from about 4 to about 12.

6. The copolymer of claim 1, wherein the copolymer has a ratio of weight average molecular weight to z-average molecular weight of from about 4 to about 5.

7. The copolymer of claim 1, wherein the copolymer has a peak molecular weight of from about 160,000 g/mol to about 195,000 g/mol.

8. The copolymer of claim 1, wherein the copolymer has a 1% flexural modulus of from about 220 kpsi to about 290 kpsi.

9. The copolymer of claim 1, wherein the copolymer has a crystallization temperature of from about 120° C. to about 140° C.

10. The copolymer of claim 1, wherein the copolymer has a crystallization enthalpy of from about 90 J/g to about 125 J/g.

11. The copolymer of claim 1, wherein the copolymer has a melting temperature of from about 150° C. to about 200° C.

12. The copolymer of claim 1, wherein the copolymer has a melting enthalpy of from about 90 J/g to about 115 J/g.

13. The copolymer of claim 1, wherein the copolymer has a percent crystallinity of equal to or greater than about 45%.

14. The copolymer of claim 1, wherein the copolymer has a heat deflection temperature of equal to or greater than about 212° F. (100° C.).

15. A film formed the copolymer of claim 1, wherein the film has a haze of from about 5% to about 60%.

16. A film formed the copolymer of claim 2, wherein the film has a haze of from about 5% to about 60%.

17. The film of claim 15, wherein the film has a clarity of greater than about 98%.

18. The film of claim 16, wherein the film has a clarity of greater than about 98%.

19. The film of claim 15, wherein the film has a gloss at 45° of from about 65 to about 110.

20. The film of claim 16, wherein the film has a gloss at 45° of from about 65 to about 110.

21. The film of claim 15, wherein the film has a tensile strength at yield of from about 5000 psi to about 7000 psi.

22. The film of claim 16, wherein the film has a tensile strength at yield of from about 5000 psi to about 7000 psi.

23. The film of claim 15, wherein the film has a tensile strength at break of from about 1500 psi to about 4000 psi.

24. The film of claim 16, wherein the film has a tensile strength at break of from about 1500 psi to about 4000 psi.
